(19) United States
(12) Patent Application Publication
(10) Pub. No.: US 2024/0403835 A1
(43) Pub. Date: Dec. 5, 2024

(54) DAMAGE DEGREE MANAGEMENT SYSTEM FOR STEAM TURBINE HIGH TEMPERATURE COMPONENTS

(71) Applicant: TOSHIBA ENERGY SYSTEMS & SOLUTIONS CORPORATION, Kawasaki-shi (JP)

(72) Inventors: Yasuteru KAWAI, Yokohama Kanagawa (JP); Tetsuya SHITAKA, Yokohama Kanagawa (JP); Kenichi KASE, Yokohama Kanagawa (JP); Yoshikazu NINOMIYA, Nerima Tokyo (JP); Tetsuya MAKINO, Kawasaki Kanagawa (JP); Yusuke SUZUKI, Yokohama Kanagawa (JP); Tsukasa TAKEUCHI, Yokohama Kanagawa (JP); Hiroyuki ICHIKAWA, Koganei Tokyo (JP); Yasunori ONO, Yokohama Kanagawa (JP)

(73) Assignee: TOSHIBA ENERGY SYSTEMS & SOLUTIONS CORPORATION, Kawasaki-shi (JP)

(21) Appl. No.: 18/404,337

(22) Filed: Jan. 4, 2024

(30) Foreign Application Priority Data
May 30, 2023 (JP) 2023-088487

(51) Int. Cl. G06Q 10/20; G07C 3/00

(52) U.S. Cl. CPC G06Q 10/20; G07C 3/00

(57) ABSTRACT

According to an embodiment, a damage degree management system for a steam turbine high temperature component, comprising a display information generator that generates display information for displaying: past damage degree related information indicating information regarding a damage degree of the steam turbine high temperature component from the past to the present calculated based on measured information; and future damage degree related information indicating information regarding a future damage degree of the steam turbine high temperature component in the future calculated based on a future operation plan input through an input screen of a user interface and the past damage degree related information.

### CROSS REFERENCE TO RELATED APPLICATIONS

This application is based upon and claims the benefit of priority from Japanese Patent Application No. 2023-088487 filed on May 30, 2023, the entire content of which is incorporated herein by reference.

### FIELD

Embodiments of the present invention relate to a damage degree management system for steam turbine high temperature components.

### BACKGROUND

High temperature parts such as a casing and a rotor used for a steam turbine gradually consume their lives over time due to creep and fatigue, and there is a risk that a crack or damage occurs on the parts in the course of time. Accordingly, in order to perform proper evaluation, measurement and non-destructive inspection of an actual machine have been conventionally required.

Recently, in a power generation facility, an introduction of renewable energy is being accelerated as a measure for reducing carbon dioxide (CO₂) emission. In power generation utilizing the renewable energy, a power generation amount changes according to weather and the like. For this reason, recently, in order to make up for the unstable power supply in the power generation utilizing the renewable energy, load following operation of thermal power plants is mainly performed.

As described above, in the thermal power plant including a steam turbine, the operation thereof shifts from one that is mainly a rated load operation to one in which load following operation of the thermal power plant is mainly performed. When the operation is shifted to load following operation of the thermal power plant, the number of times of start up and stop and a frequency of load fluctuation increase. As a result of this, an operating temperature of high temperature parts in particular, namely, rotors and turbine casings of a high-pressure turbine and an intermediate-pressure turbine used under a high-temperature environment, of the steam turbine, is difficult to maintain a steady state. This increases a crack propagation degree due to fatigue damage, which becomes a severe condition in terms of remaining life.

### BRIEF DESCRIPTION OF THE DRAWINGS

FIG. 1 is a system diagram schematically illustrating a configuration of a power plant including a steam turbine provided with a damage degree management system according to a first embodiment.

FIG. 2 is a block diagram illustrating a functional configuration of the damage degree management system according to the first embodiment.

FIG. 3 is a diagram illustrating one example of an input screen of an excavation depth of a high-pressure outer casing to be displayed on a user interface in the damage degree management system according to the first embodiment.

FIG. 4 is a diagram illustrating one example of an input screen of a future operation plan to be displayed on the user interface in the damage degree management system according to the first embodiment.

FIG. 5 is a flow chart illustrating a procedure of a crack propagation evaluation step performed by the damage degree management system according to the first embodiment.

FIG. 6 is a flow chart illustrating a procedure of a future prediction calculation performed by the damage degree management system according to the first embodiment.

FIG. 7 is a diagram illustrating one example of results of a fixed cycle calculation and a future prediction calculation of a high-pressure outer casing to be displayed on the user interface in the damage degree management system according to the first embodiment.

FIG. 8 is a diagram illustrating one example of results of a fixed cycle calculation and a future prediction calculation of an intermediate-pressure turbine rotating part to be displayed on the user interface in the damage degree management system according to the first embodiment.

FIG. 9 is a flow chart for explaining a basic environment setting step in a damage degree management method performed by the damage degree management system according to the first embodiment.

FIG. 10 is a flow chart for explaining a procedure of fixed cycle calculation processing in the damage degree management method performed by the damage degree management system according to the first embodiment.

FIG. 11 is a flow chart for explaining a procedure of future prediction calculation processing in the damage degree management method performed by the damage degree management system according to the first embodiment.

FIG. 12 is a first flow chart for explaining future prediction calculation processing in a damage degree management system according to a second embodiment.

FIG. 13 is a second flow chart for explaining the future prediction calculation processing in the damage degree management system according to the second embodiment.

FIG. 14 is a diagram illustrating one example of a display screen in the damage degree management system according to the second embodiment.

FIG. 15 is a diagram illustrating one example of a selection screen for selecting a reference calculation result to be displayed on a user interface in the damage degree management system according to the second embodiment.

### DETAILED DESCRIPTION

A problem to be solved by the present invention is to provide a damage degree management system for steam turbine high temperature components with which it is possible to recognize, in chronological order, a damage degree from the past to the present predicted based on measured information, and a future damage degree predicted based on a future operation plan.

According to an aspect of the present invention, there is provided a damage degree management system for a steam turbine high temperature component, the system comprising a display information generator configured to generate display information for displaying: past damage degree related information indicating information regarding a damage degree of the steam turbine high temperature component from the past to the present calculated based on measured information; and future damage degree related information indicating information regarding a future damage degree of the steam turbine high temperature component in the future calculated based on a future operation plan input through an input screen of a user interface and the past damage degree related information.

Hereinafter, a damage degree management system for steam turbine high temperature components (referred to as “damage degree management system”, hereinafter) according to an embodiment of the present invention will be explained with reference to the drawings. Here, mutually the same or similar parts will be denoted by common reference signs, and an overlapped explanation will be omitted.

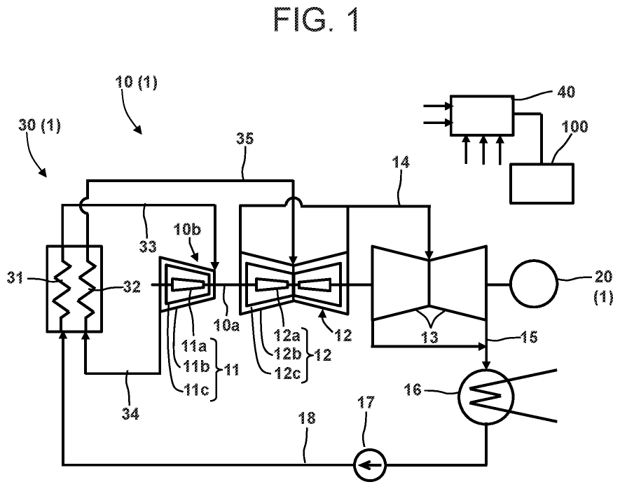

FIG. 1 is a system diagram schematically illustrating a configuration of a power plant 1 including a steam turbine 10 provided with a damage degree management system 100 according to the first embodiment.

The power plant 1 includes the steam turbine 10, a generator 20, and a heat source apparatus 30. Here, the heat source apparatus 30 includes a boiler 31 and a reheater 32.

As illustrated in FIG. 1, the steam turbine 10 includes a high-pressure turbine 11, an intermediate-pressure turbine 12, a low-pressure turbine 13, a condenser 16, a feed water pump 17, and the damage degree management system 100. The high-pressure turbine 11 includes a high-pressure turbine rotating part 11a, a high-pressure outer casing (high-pressure outer casing) 11b, and a high-pressure inner casing (high-pressure inner casing) 11c. Further, a case is exemplified in which two intermediate-pressure turbines 12 are provided. Each of the intermediate-pressure turbines 12 includes an intermediate-pressure turbine rotating part 12a, an intermediate-pressure outer casing 12b, and an intermediate-pressure inner casing 12c. Here, each of the high-pressure turbine rotating part 11a and the intermediate-pressure turbine rotating part 12a is a rotor shaft in which a plurality of moving buckets (blades) are implanted.

The boiler 31 heats water fed from the steam turbine 10 side to generate steam. The steam generated in the boiler 31 is introduced into the high-pressure turbine 11 through a main steam pipe 33. The high-pressure turbine 11 converts thermal energy of the steam introduced through the main steam pipe 33 into rotational energy of the high-pressure turbine rotating part 11a and the like, and discharges the steam after performing work in the high-pressure turbine 11 to a cold reheat pipe 34. The steam discharged to the cold reheat pipe 34 is introduced into the reheater 32. The reheater 32 reheats the introduced steam, and leads out the reheated steam to a hot reheat pipe 35.

The intermediate-pressure turbine 12 converts thermal energy of the steam introduced through the hot reheat pipe 35 into rotational energy, and discharges the steam after performing work in the intermediate-pressure turbine 12 to a crossover pipe 14. The low-pressure turbine 13 converts thermal energy of the steam introduced through the crossover pipe 14 into rotational energy of a low-pressure turbine rotating part (not illustrated) and the like, and discharges the steam after performing work in the low-pressure turbine 13 to an exhaust hood 15. The generator 20 is driven by the high-pressure turbine 11, the intermediate-pressure turbine 12, and the low-pressure turbine 13, to thereby convert the rotational energy into electric energy to perform power generation.

The condenser 16 condenses the steam introduced through the exhaust hood 15 to produce condensed water. The feed water pump 17 feeds the condensed water produced by the condenser 16 to the boiler 31 as feed water through a feed water pipe 18.

The damage degree management system 100 is a system for managing soundness regarding a crack propagation due to fatigue damage and creep damage in the steam turbine 10. Respective condition values or state quantities related to the steam turbine 10 are measured by not-illustrated respective detectors, and signals thereof are taken into an on-site control system 40 such as DCS (Distributed Control System), for example. The damage degree management system 100 acquires measurement data required for the damage degree management from the on-site control system 40. Note that details of the damage degree management system 100 will be described later. Note that hereinbelow, a high temperature part of the steam turbine 10 will be described as an example, as a target to be managed by the damage degree management system 100, but contents below may also be applied to a part such as a casing of a steam valve, for example, in which a crack occurs due to creep and fatigue.

Here, in the present embodiment, the high temperature parts of the steam turbine 10 to be targets of the damage degree management system 100 are the high-pressure turbine rotating part 11a, the high-pressure outer casing 11b, and the high-pressure inner casing 11c of the high-pressure turbine 11, and the intermediate-pressure turbine rotating part 12a, the intermediate-pressure outer casing 12b, and the intermediate-pressure inner casing 12c of the intermediate-pressure turbine 12. Note that hereinafter, the high-pressure turbine rotating part 11a and the intermediate-pressure turbine rotating part 12a will be collectively called a turbine rotor 10a. Further, the high-pressure outer casing 11b, the high-pressure inner casing 11c, the intermediate-pressure outer casing 12b, and the intermediate-pressure inner casing 12c will be collectively called a turbine casing 10b. Further, the turbine rotor 10a will be called a rotor as well hereinbelow.

### <Configuration of Damage Degree Management System>

Next, the damage degree management system 100 will be explained.

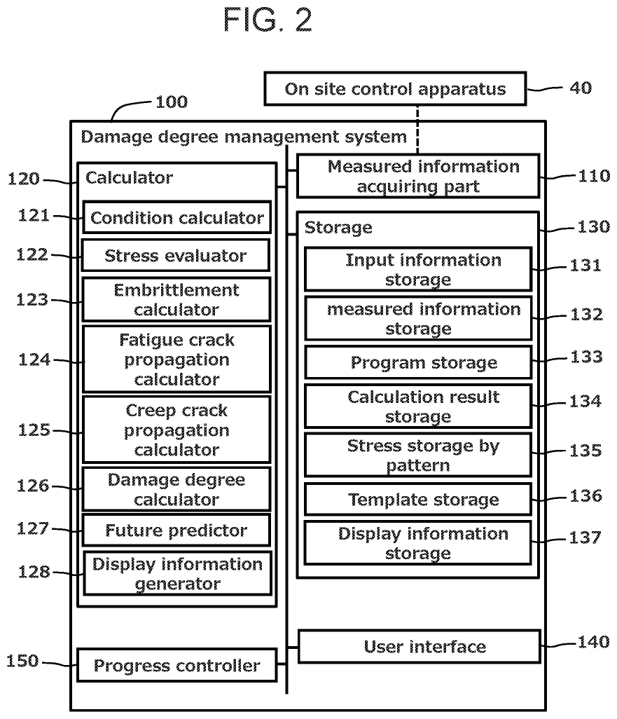

FIG. 2 is a block diagram illustrating a functional configuration of the damage degree management system 100 according to the first embodiment.

The damage degree management system 100 is, for example, a system that manages the damage degree by predicting a crack propagation degree, a crack length, and a damage degree from the past to the present based on information measured by an actual machine (referred to as “measurement information” or “measured information”, hereinafter), and predicting a crack propagation degree, a crack length, and a damage degree in the future based on an operation plan in the future or operation condition assumed in the future. Further, the damage degree management system 100 generates display information for making a prediction result of the damage degree and the like to be displayed on a display part, for example. Note that the measurement information includes time information at a time when the measurement is performed.

As illustrated in FIG. 2, the damage degree management system 100 includes a measured information acquiring part 110, a calculator 120, a storage 130, a user interface 140, and a progress controller 150. The damage degree management system 100 is, for example, a computer system, but it may also be an aggregation of individual devices and apparatuses having functions of respective elements.

The measured information acquiring part 110 is an interface that acquires measurement data required for the damage degree management from the on-site control system 40. The measured information acquiring part 110 acquires, from measurement data taken into the on-site control system 40, measurement information (also referred to as measurement data, hereinafter) regarding the steam turbine 10 during operation required for the damage degree management, at a predetermined time interval (measurement information acquisition cycle) of one minute or the like, for example.

The measurement information is steam conditions such as, for example, a main steam pressure, a main steam temperature, and a reheat steam temperature, a rotation number of the turbine rotor 10a, condition values inside the turbine such as, for example, an inlet pressure or an outlet pressure of a nozzle at a first stage of the high-pressure turbine 11, and a condition values such as a temperature of the turbine casing 10b.

The measured information acquiring part 110 outputs the acquired measurement information to a measured information storage 132 of the storage 130. The measured information storage 132 houses and stores this measurement information.

The calculator 120 includes a condition calculator 121, a stress evaluator 122, an embrittlement calculator 123, a fatigue crack propagation calculator 124, a creep crack propagation calculator 125, a damage degree calculator 126, a future predictor 127, and a display information generator 128.

The condition calculator 121, the stress evaluator 122, the embrittlement calculator 123, the fatigue crack propagation calculator 124, the creep crack propagation calculator 125, and the damage degree calculator 126 to be explained below, of the calculator 120, are parts related to fixed cycle calculation processing being calculation processing regarding a crack length “a”, a crack depth “d”, and a damage degree D from the past to the present.

The condition calculator 121 performs an estimation calculation of a condition values used for heat transfer calculation, based on measurement information acquired for each measurement information acquisition cycle of one minute or the like, for example, by the measured information acquiring part 110. Concretely, the measurement information acquisition cycle of one minute or the like, for example, is divided into intervals of condition values calculation (stress calculation cycle) of 10 seconds or the like, for example. By assuming that a change in the condition values between respective pieces of measurement information acquired for each measurement information acquisition cycle is a linear one, the condition values for each stress calculation cycle is calculated through interpolation.

Based on the condition values for each stress calculation cycle calculated by the condition calculator 121, the stress evaluator 122 calculates stresses at an evaluation part, concretely, a thermal stress and a stress due to an external force such as a pressure and a centrifugal force.

The embrittlement calculator 123 calculates an embrittlement degree of a material of the evaluation part based on material data housed in a program storage 133 that houses a program installed for the damage degree management system 100, a temperature of the evaluation part calculated by the condition calculator 121, and the like.

The fatigue crack propagation calculator 124 calculates a fatigue crack propagation speed at the evaluation part at a damage degree calculation cycle of one day or the like, for example, based on the stress at the evaluation part calculated by the stress evaluator 122 and the embrittlement degree of the material of the evaluation part calculated by the embrittlement calculator 123. Consequently, a new crack propagation degree can be obtained.

The creep crack propagation calculator 125 calculates a creep crack propagation speed based on the stress at the evaluation part calculated by the stress evaluator 122, the embrittlement degree of the material of the evaluation part calculated by the embrittlement calculator 123, and the material data housed in the program storage 133. Consequently, a new crack propagation degree can be obtained.

Note that hereinafter, the fatigue crack propagation and the creep crack propagation will be collectively called a crack propagation, and the fatigue crack propagation degree and the creep crack propagation degree will be collectively called a crack propagation degree.

The damage degree calculator 126 multiplies the “crack length a” obtained by the fatigue crack propagation speed calculated by the fatigue crack propagation calculator 124 and the creep crack propagation speed calculated by the creep crack propagation calculator 125 by a conversion constant, to thereby convert it into the “crack depth d”. The “crack depth d” is divided by a “critical crack depth dₜₕ”, to thereby calculate the damage degree D. The conversion constant and the “critical crack depth dₜₕ” are housed in the program storage 133 of the storage 130 to be described later, as data pertaining to the program installed in the damage degree management system 100. The “critical crack depth dₜₕ” is, concretely, a crack depth [mm] corresponding to a rotor inspection management value and a turbine casing replacement management value to be described later.

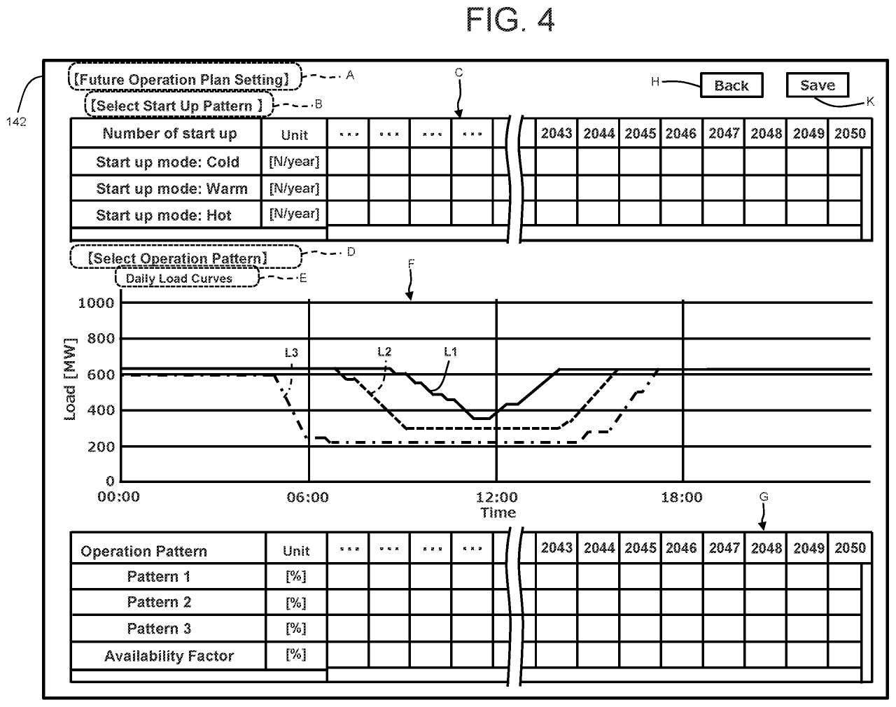

The future predictor 127 performs future prediction calculation processing being calculation processing regarding the crack length a, the crack depth d, and the damage degree D in the future, namely, in a period after the present. The future predictor 127 does not perform a calculation such as the fixed cycle calculation processing, but it previously evaluates and stores a stress generated for each operation pattern based on information input as a future operation plan (refer to FIG. 4) in a user interface 140 to be described later, reads the stress, calculates a damage degree, and integrates the damage degrees, to thereby calculate an annual damage degree of each year. Here, the information input as the operation plan is a condition of calculation, and thus it will be called an operation condition as well hereinbelow. The future predictor 127 performs the future prediction calculation processing based on two conditions of a start-up condition and an operation pattern.

The start-up condition is based on the number of times in a year of each of three patterns of a cold start up, a warm start up, and a hot start up, for example. Here, the cold start up means a start-up when a metal temperature of an inner surface of a first stage of a high-pressure turbine at a time of starting up the steam turbine is a predetermined temperature (for example, 180° C.) or less, and generally corresponds to a start up after a stopping time of several days or more. The warm start up means a start-up when the metal temperature of the inner surface of the first stage of the high-pressure turbine at the time of starting up the steam turbine is within a predetermined range (for example, 180 to 350° C.), and generally corresponds to a start up after stopping of about two to three days. Further, the hot start up means a start up in a period of time as short as possible within a range in which values of various transient states that appear at the time of start-up do not exceed limit values.

Further, the operation pattern is a pattern of an electric power [MW] at each time in one day, in other words, a pattern of temporal change of the electric power [MW] in one day. A ratio (%) of the number of days of each of the previously-set plurality of operation patterns to the number of days of one year is input. Note that hereinbelow, the operation pattern is sometimes referred to as a daily load condition, and a curve indicating the operation pattern is sometimes referred to as a daily load curve.

With respect to each pattern of the start-up condition and the daily load condition, a stress history is previously calculated, and stored and housed in a stress storage by pattern 135 of the storage 130. Note that these values may also be housed in the program storage 133 together with a program, as a data part in the program installed and housed in the program storage 133 of the storage 130.

The future predictor 127 calculates an in-operation time based on the availability factor of each pattern input as the future operation plan. Further, from the stress history stored in the stress storage by pattern 135, the future predictor 127 calculates the crack length a, the crack depth d, and an increment of the damage degree D, based on a method similar to that of the fixed cycle calculation. The future predictor 127 adds the increment of the damage degree D to a damage degree D of the previous year, to thereby calculate a damage degree D of the calculation target year. Further, it is assumed that the damage degree of the year increases linearly.

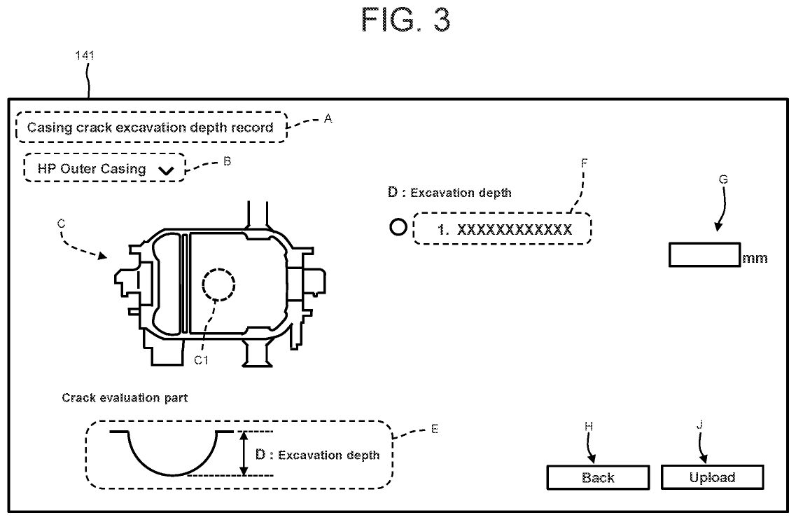

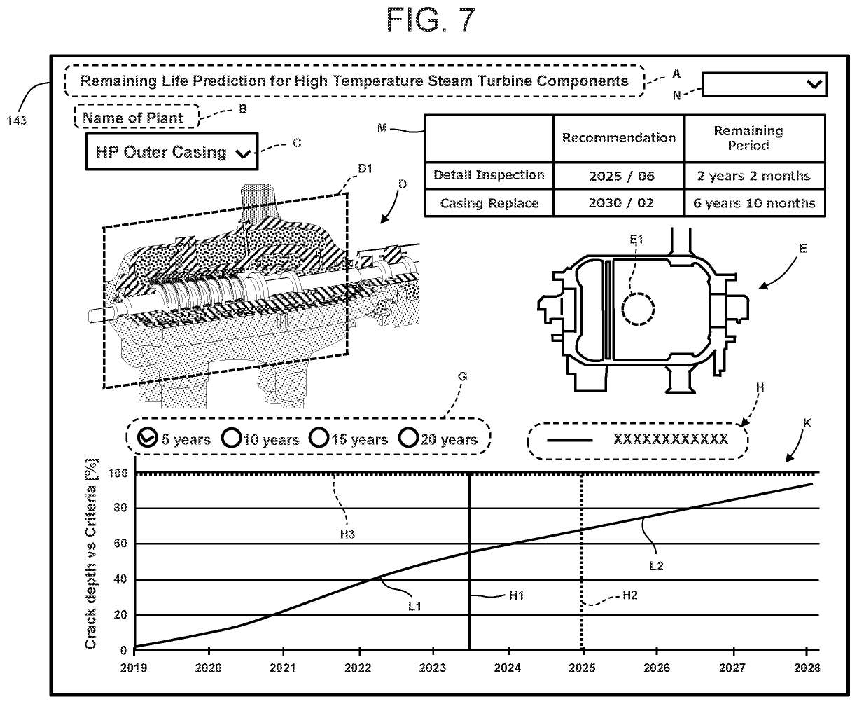

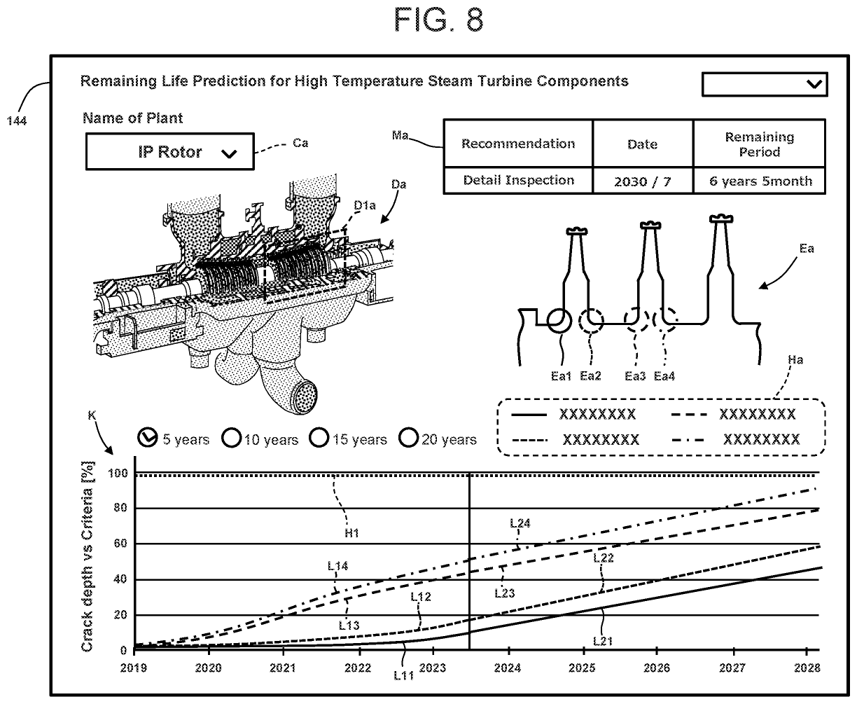

The display information generator 128 generates display information of an input screen and an output screen to be displayed on the user interface 140. The input screen will be explained later while citing FIG. 3 and FIG. 4, and the output screen will be explained later while citing FIG. 7 and FIG. 8.

The storage 130 includes an input information storage 131, the measured information storage 132, the program storage 133, a calculation result storage 134, the stress storage by pattern 135, a template storage 136, and a display information storage 137. The storage 130 is realized by, for example, a hard disk drive, a nonvolatile memory device, or the like. The storage 130 may not be physically integrated with the damage degree management system 100, and may be connected to the system via a not-illustrated network.

The input information storage 131 stores, for example, periodic inspection information including a record obtained by removing a crack or flaw of a turbine casing through a mechanical method to smooth a surface of the turbine casing, namely, a record of excavation, a future operation plan, various setting conditions, and the like input via the user interface 140.

The measured information storage 132 sequentially houses and stores the measurement information acquired by the measured information acquiring part 110.

The program storage 133 houses a program installed in the damage degree management system 100. At this time, the program storage 133 also houses data for calculation pertaining to the program.

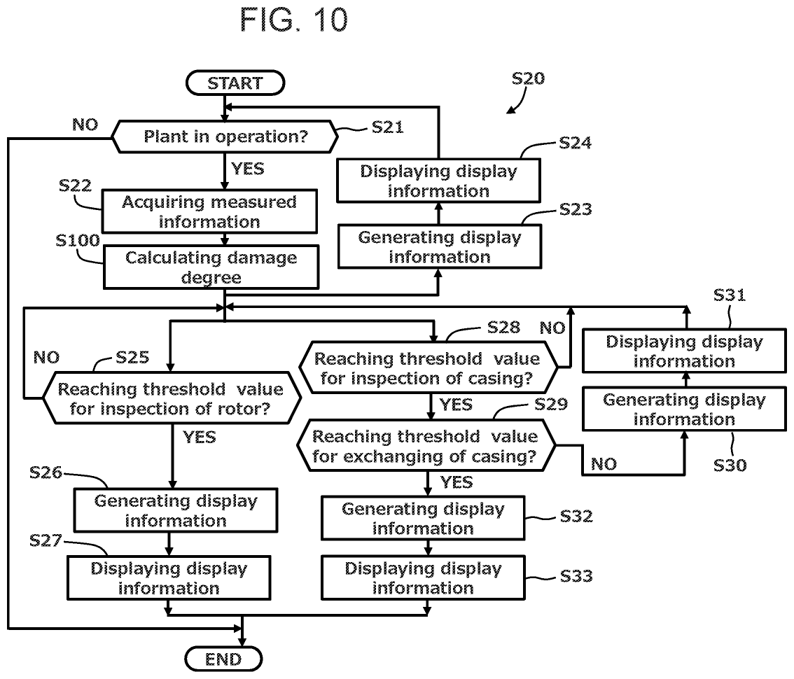

The calculation result storage 134 sequentially houses and stores results calculated by the calculator 120. The calculation result storage 134 stores, as information regarding the crack propagation degree (past crack propagation degree), the crack length (past crack length), the crack depth (past crack depth), and the damage degree (past damage degree) from the past to the present, calculation results of the crack propagation degree, the crack length, the crack depth, and the damage degree from the past to the present in the fixed cycle calculation processing to be explained later while citing FIG. 10, and the like, for example. Note that this information functions as past damage degree related information.

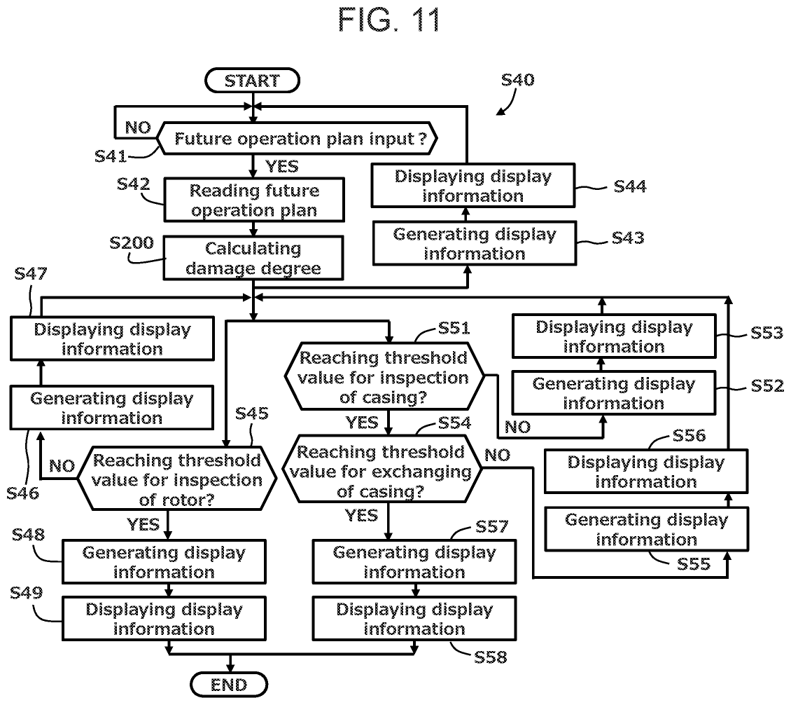

Further, the calculation result storage 134 stores, as information regarding a future damage degree to be explained later while citing FIG. 11, calculation results of a crack propagation degree (future crack propagation degree), a crack length (future crack length), a crack depth (future crack depth), and a damage degree (future damage degree) in the future, a threshold value for inspection, a recommended inspection timing, a replacement threshold value, a replacement recommendation date, and the like, for example. These pieces of information function as future damage degree related information.

Here, the threshold value for inspection is a predetermined value at which the performance of inspection is recommended at a time point where a targeted index reaches the predetermined value. Further, the recommended inspection timing indicates a time point at which the recommended inspection is performed. Specifically, in the case of the turbine rotor 10a, a targeted index is a damage degree, and the threshold value for inspection is a predetermined damage degree. Further, in the case of the turbine casing 10b, a targeted index is a period from the start of use of the turbine casing 10b, and the threshold value for inspection is a predetermined period (10 years, for example) from the start of use of the turbine casing 10b. This threshold value for inspection also functions as the past damage degree related information.

Further, the threshold value for exchanging casing is a threshold value regarding the turbine casing 10b. A targeted index regarding the threshold value for exchanging casing is a damage degree, and the threshold value for exchanging casing is a predetermined damage degree. Further, the recommendation date is a time point at which the damage degree of the turbine casing 10b reaches the threshold value for exchanging casing.

The stress storage by pattern 135 houses the previously-calculated stress history, temperature history, and the like regarding each pattern in the future operation plan input via the user interface 140. Note that the stress storage by pattern 135 may also be a part of the program storage 133. Specifically, it may be housed in the program storage 133 as a part of the data for calculation pertaining to the program, and that part may be called the stress storage by pattern 135.

The template storage 136 houses templates being common parts when generating images to be displayed on the user interface 140.

The display information storage 137 houses the display information generated by the display information generator 128.

The user interface 140 includes a display part that displays various pieces of information to a user (manager), and an input device with which the user inputs the various pieces of information. The display part is formed of a display or the like, for example. Further, the display part may also be formed of a touch panel including a function of a screen for display and including a function as an input device capable of directly performing input on the screen. The input device may be formed of, for example, a keyboard, a mouse, and the like. The input device includes an information exchange terminal with respect a USB port or the like, capable of inputting the periodic inspection information including the record of the removing crack and flaw of the turbine casing, various setting conditions, and the like based on a predetermined format, for example. Note that the input function of the display part may also be used, as described above.

Regarding the user interface 140, an input part thereof, in particular, may be different between one for a manager of the power plant 1 and one for a manager of a manufacturer of the steam turbine 10. Specifically, there may also be a case where an input cannot be performed by the manager of the power plant 1, such as an input of an excavation depth of the turbine casing 10b to be exemplified later.

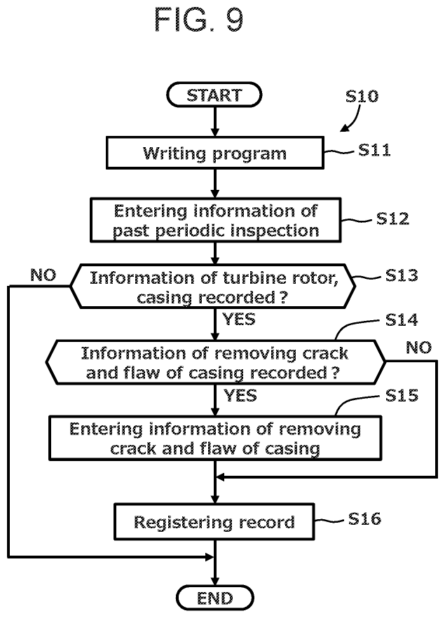

The progress controller 150 controls the progress of respective flows in a damage degree management method performed by the damage degree management system 100. The progress controller 150 also performs determination regarding respective determination steps in these flows. Concretely, the progress controller 150 performs determination in flows illustrated in FIG. 9 to FIG. 11 to be described later, and further, it commands a part that should fulfill a relevant function in the damage degree management system 100 in each step to execute the function. As the progress controller 150, for example, a programmable logic controller may be used.

### <Input Screen>

Hereinafter, as a screen capable of directly performing an input therein of the user interface 140, an input screen of an excavation of the turbine casing 10b, namely, the removing crack and flaw amount of the turbine casing 10b (excavation diagram) in the periodic inspection will be explained by citing the high-pressure outer casing 11b as an example, with reference to FIG. 3. In the case of the turbine casing 10b, when the crack or flaw is confirmed in the periodic inspection, that part is excavated, namely, removed. A removal amount thereof is kept in the record of the periodic inspection. The removal amount regarding each part of the turbine casing 10b can be read from the record of the periodic inspection, and input from an input screen. The input is performed by a manufacturer of the steam turbine 10.

FIG. 3 is a diagram illustrating one example of an input screen 141 of an excavation depth of the high-pressure outer casing 11b to be displayed on the user interface 140 in the damage degree management system 100 according to the first embodiment. FIG. 3 exemplifies a case of the high-pressure outer casing 11b of the turbine casing 10b. As described above, the input is performed by the manufacturer of the steam turbine 10, so that this input screen 141 is displayed only on the manufacture side.

Note that “excavation” means that a crack or flaw on a surface of a member is removed to smooth the surface, so that it will be referred to as “removing crack and flaw” as well.

On the input screen 141, at an A portion surrounded by a broken line at the upper left, “Casing crack excavation depth record” is displayed as a heading of a turbine casing crack excavation depth record.

At a B portion surrounded by a broken line below the heading, options of a target component are pull-down displayed when touching a “v” portion on the right side. The input screen 141 indicates a case where the “high-pressure outer casing” is selected, and “HP Outer Casing” being the selected target component is displayed.

At a portion indicated by an arrow mark C below the display of the target component on the input screen 141, a diagram corresponding to the selected target component is displayed. On the input screen 141, the “high-pressure outer casing” is selected, and thus a diagram of the high-pressure outer casing 11b is displayed.

At the C portion on the input screen 141, an example of a position of a damage degree evaluation part (excavation depth input part) is displayed by an outlined circle mark C1. There is a similar circle mark also in a diagram displayed regarding each target component including a case of another target component, and the outlined circle mark and the target component are displayed as a set. If there is a circle mark in addition to the circle mark C1, the marks may be displayed based on different types of lines or different colors, for example.

On the input screen 141, an E portion surrounded by a broken line below a heading of “Crack Evaluation Part” corresponds to a diagram of an excavation part, and is common to each excavation diagram.

On the input screen 141, an F portion of “Evacuation depth” on the right side corresponds to an input portion of an excavation amount. A number and a name of a part are displayed. In a quadrangular frame indicated at a G portion on the right side of the name of the part, the excavation depth can be input in a unit of mm.

At the lower right on the input screen 141, “Back” at an H portion and “Upload” at a J portion are displayed side by side. When “Back” at the H portion is clicked, the input contents are cancelled and the screen returns to the previous screen. Further, when “Upload” at the J portion is clicked, the input contents are uploaded in the damage degree management system 100. Specifically, excavation amount data of a relevant part housed in the input information storage 131 is rewritten into the excavation amount input this time.

On the input screen 141 explained above, the heading at the A portion, the explanatory diagram of the excavation part at the E portion, the heading at the D portion, the H portion, and the J portion are common to respective excavation diagrams, and are housed in the template storage 136 as common diagram data.

FIG. 4 is a diagram illustrating one example of an input screen 142 of a future operation plan to be displayed on the user interface 140 in the damage degree management system 100 according to the first embodiment.

At an A portion at the upper left of the input screen 142, a heading of “Future operation plan setting” is displayed.

At a B portion below the heading, a small title of “Select Start Up Pattern” is displayed, and below the small title, a table C for input of “Select Start Up Pattern” is displayed.

The table C for input of “Select Start Up Pattern” is a table for inputting the number of times of each start up mode in each year. The table C indicates, from the top, “Start up mode: Cold”, “Start up mode: Warm”, and “Start up mode: Hot”. Frames for the year to which the present belongs and years thereafter, are indicated in a horizontal direction.

At a D portion below the table C for input of “Select Start Up Pattern”, a title of “Select Operation Pattern” is displayed.

Further, at an E portion below the title, a small title of “Daily Load Curve” is displayed, and below the small title, in the example of FIG. 4, a graph F illustrating three curves indicating temporal change of loads in one day (daily load curves) as operation patterns, is displayed. In the graph F, a horizontal axis is a time in one day, and a vertical axis is a load (“Load [MW]”). Here, the load may be set to the electric power [MW] of the generator 20.

Below the graph F, a table G for inputting operation pattern is displayed. Respective horizontal columns in the table G are fields for inputting the operation pattern, a unit, and the year to which the present belongs and respective years thereafter. Respective vertical rows in the table G correspond to patterns 1 to 3 and an availability factor [%] in each year. The input field of each of the patterns 1 to 3 corresponds to a ratio [%] of the number of days of performing the operation of the relevant pattern to the number of days of one year. A value of the availability factor [%] is a total ratio [%] of the patterns 1 to 3. As described above, the operation condition in the future, namely, the start up pattern and the operation pattern in each year can be set in an arbitrary manner.

At the upper right portion of the input screen 142, a selection display H of “Back” and a selection display K of “Save” are displayed. When “Save” is pressed, the information input in the table C and the table G is housed and stored in the display information storage 137. Further, when “Back” is pressed without pressing “Save”, the display of information input in the table C and the table G returns to the display before the input.

Note that here, when it is expressed such that the selection display is “pressed”, this is set to collectively mean an operation of specifying or selecting a relevant portion by acting on the portion from the outside, such as an operation of touching on the touch screen, or an operation of clicking with a cursor. The same applies to the description below.

### <Crack Propagation Evaluation>

Here, a crack propagation evaluation in the fixed cycle calculation processing will be described.

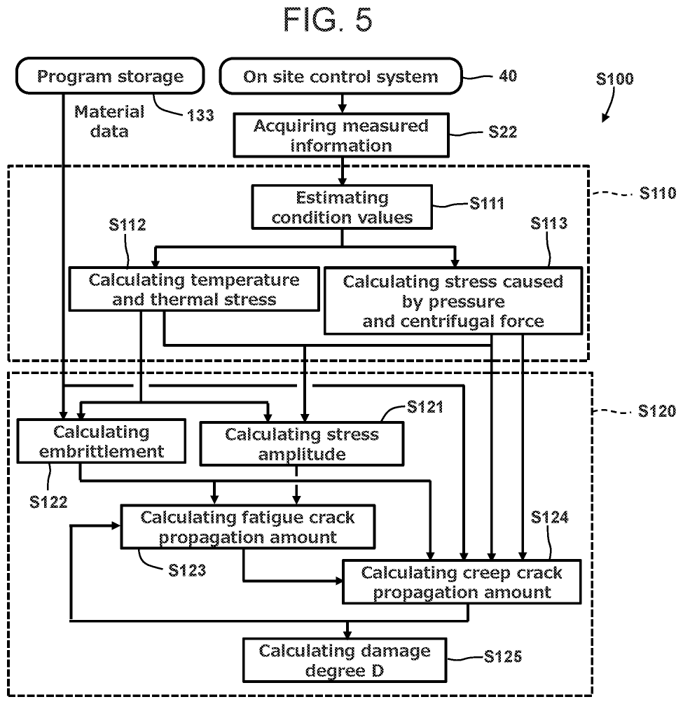

FIG. 5 is a flow chart illustrating a procedure of a crack propagation evaluation step S100 performed by the damage degree management system 100 according to the first embodiment.

In advance of the crack propagation evaluation step S100, the measured information acquiring part 110 acquires the measurement information from the on-site control system 40 (step S22).

Here, an evaluation target part of the crack propagation evaluation is a part selected based on a result of previously performing evaluation regarding the turbine rotor 10a and the turbine casing 10b.

The crack propagation evaluation step S100 includes a condition values and stress evaluation step S110, and a damage degree evaluation step S120.

As the condition values and stress evaluation step S110, the condition calculator 121 first performs an estimation calculation of a condition values used for heat transfer calculation based on acquired measurement information (measured information) (step S111). Concretely, a measurement information acquisition cycle of one minute, for example, is first divided into intervals of condition values calculation (stress calculation cycle) of 10 seconds, for example. By assuming that the change between respective pieces of measurement information acquired for each measurement information acquisition cycle is a linear one, the condition values for each stress calculation cycle of 10 seconds, for example, is calculated through interpolation.

The condition calculator 121 calculates a steam temperature, a pressure, and a heat transfer coefficient of each part used for the heat transfer calculation, based on the condition values for each stress calculation cycle.

Next, the stress evaluator 122 performs a temperature and thermal stress evaluation (step S112). Specifically, the stress evaluator 122 first performs heat transfer calculation based on the steam temperature and the heat transfer coefficient of each part obtained for each stress calculation cycle, to thereby calculate an estimated value of the temperature of the evaluation part. Note that a shape (heat transfer area) of the evaluation part, and physical property values such as a specific heat and a heat transfer coefficient required at this time are housed in the program storage 133 as data pertaining to the program. Subsequently, the stress evaluator 122 calculates the thermal stress at the evaluation part based on temperature distributions thereof.

The stress evaluator 122 performs a stress evaluation based on a pressure and a centrifugal force, in parallel with step S112 (step S113). Concretely, the stress evaluator 122 calculates a stress distribution of a turbine casing based on a steam pressure. Further, the stress evaluator 122 calculates a stress due to a centrifugal force at the turbine rotating part. As a result of this, the stress due to the pressure and the centrifugal force at the evaluation part can be obtained.

In the next damage degree evaluation step S120, the calculator 120 calculates a crack propagation degree by using the evaluation results in step S112 and step S113, to thereby perform a damage degree and remaining life calculation. Detailed steps thereof will be explained below.

First, the stress evaluator 122 performs a stress amplitude evaluation regarding each evaluation part (step S121). Concretely, the stress evaluator 122 first calculates a total stress value being a total value of the thermal stress and the stress due to the pressure and the centrifugal force. Subsequently, the stress evaluator 122 derives a stress amplitude by using a rain flow method, for example, from a temporal change of the total stress value over a predetermined time width. Here, the predetermined time width is a calculation cycle (damage degree calculation cycle) in the evaluation of the damage degree and the like performed in the damage degree evaluation step S120. The damage degree calculation cycle is, for example, one day.

In parallel with step S121, the embrittlement calculator 123 performs an embrittlement evaluation (step S122). The embrittlement as a reduction in absorbed energy of the metal material is normally expressed by FATT (Fracture Appearance Transition Temperature) being a test temperature, in a Charpy impact test, at which a proportion of ductile fracture surface and a proportion of brittle fracture surface become equal. In an embrittlement degree evaluation performed by the embrittlement calculator 123, a saturated embrittlement degree ΔFATT∞ of the material of the evaluation part is first calculated based on the material data housed in the program storage 133 that houses the program installed for the damage degree management system 100, and the temperature of the evaluation part calculated in step S112. Next, the embrittlement calculator 123 calculates an embrittlement ratio R_{F} of the material of the evaluation part to the saturated embrittlement degree ΔFATT∞ of the embrittlement degree FATT, based on an impurity element amount in the material of the evaluation part based on the material data in the initial setting data, and an operating temperature (retention temperature) and an operating time (retention time) based on an operation state. Next, the embrittlement calculator 123 calculates an embrittlement degree ΔFATT by (saturated embrittlement degree ΔFATT∞×embrittlement ratio R_{F}). The embrittlement degree ΔFATT is housed and stored in the calculation result storage 134. The embrittlement degree ΔFATT calculated for each damage degree calculation cycle is added to the integrated embrittlement degree ΔFATT read from the calculation result storage 134 to calculate a newly integrated embrittlement degree ΔFATT, and the newly integrated embrittlement degree ΔFATT is housed and stored in the calculation result storage 134.

Next, a fatigue crack propagation degree evaluation performed by the fatigue crack propagation calculator 124 (step S123) and a creep crack propagation degree evaluation performed by the creep crack propagation calculator 125 (step S124) will be explained, but in advance of that, an initial crack will be explained.

When evaluating the crack propagation degree, a value of initial crack (crack length or depth), namely, a value of crack at a time of zero is required as an analysis condition, so that a very little value is set. The value of initial crack of each evaluation part is housed in the program storage 133 that houses the program, as data pertaining to the program installed for the damage degree management system 100. This pertained data is housed in the calculation result storage 134 as initial data. Further, regarding the turbine casing 10b, when the removing crack and flaw (excavation) has been performed at the time of periodic inspection, the information of initial crack stored in the input information storage 131 is rewritten into a value input via the user interface 140 on the input screen for evaluation target component indicated by an example of the input screen 141 in FIG. 3.

In each of the fatigue crack propagation degree evaluation performed by the fatigue crack propagation calculator 124 (step S123) and the creep crack propagation degree evaluation performed by the creep crack propagation calculator 125 (step S124), an increment of crack propagation degree for each damage degree calculation cycle is calculated, and the increment is added to the crack propagation degree stored in the calculation result storage 134, to thereby calculate a new crack propagation degree. The crack propagation degree stored in the calculation result storage 134 is rewritten into the new crack propagation degree.

First, the fatigue crack propagation calculator 124 performs a fatigue crack propagation degree evaluation based on the results of the stress amplitude evaluation in step S121 and the embrittlement evaluation in step S122 (step S123).

The fatigue crack propagation calculator 124 calculates a fatigue crack propagation speed (da/dN), and reads a value of the crack length a housed in the calculation result storage 134 and adds an increment due to the fatigue crack propagation speed to the value of crack length a, to thereby calculate a new crack length a. The crack length a housed in the calculation result storage 134 is rewritten into the new crack length a.

The fatigue crack propagation calculator 124 calculates a stress intensity factor difference ΔK during this period, based on the result of the stress amplitude evaluation (S121), to thereby calculate the fatigue crack propagation speed (da/dN). The fatigue crack propagation calculator 124 calculates coefficients of a calculation equation of the fatigue crack propagation speed (da/dN), based on the embrittlement degree ΔFATT calculated by the embrittlement calculator 123.

Next, the creep crack propagation calculator 125 performs the creep crack propagation degree evaluation based on the thermal stress calculated in step S112, the stress calculated in step S113, and the material data such as a yield strength housed in the program storage 133 (step S124). The creep crack propagation calculator 125 calculates a creep crack propagation speed (da/dt) by using a calculation equation that depends on the stress intensity factor K and the temperature, for example. The creep crack propagation calculator 125 calculates coefficients of a calculation equation of the creep crack propagation speed based on the embrittlement degree FATT calculated by the embrittlement calculator 123. Note that it is also possible to perform evaluation using C*, J*, or modified J-integral according to need, other than the evaluation using the stress intensity factor K.

The creep crack propagation calculator 125 calculates the creep crack propagation speed (da/dt), and reads a value of the crack length a housed in the calculation result storage 134 and adds an increment due to the creep crack propagation speed to the value of crack length a, to thereby calculate a new crack length a. The crack length a housed in the calculation result storage 134 is rewritten into the new crack length a. As a result of this, the crack length a calculated by the creep crack propagation calculator 125 becomes an initial value of the calculation of the crack propagation degree performed by the fatigue crack propagation calculator 124 at the next step. Further, regarding the turbine casing 10b, when the removing crack and flaw (excavation) has been performed at the time of periodic inspection, an initial value right after the periodic inspection becomes a value input via the user interface 140 on the input screen for the evaluation target component, as described above.

Note that when the removing crack and flaw (excavation) has been performed at the time of periodic inspection as described above and thus the information of the initial crack stored in the input information storage 131 has been rewritten, the initial condition of the crack propagation degree calculation in the fixed cycle calculation and the future prediction calculation processing is changed, so that a display of a display curve L1 corresponding to the fixed cycle calculation on the output screen 143 is deleted, and is switched to a display corresponding to a new fixed cycle calculation. Further, a display curve L2 corresponding to the future prediction calculation processing is changed to a curve L2 after changing the initial condition.

Next, the damage degree calculator 126 performs a damage degree and remaining life calculation (step S125). The damage degree calculator 126 reads the “crack length a” newly rewritten in the calculation result storage 134, converts the “crack length a” into the “crack depth d”, and then divides the “crack depth d” by the “critical crack depth dₜₕ” housed in the program storage 133, to thereby calculate the damage degree D.

### <Calculation of Future Damage Degree>

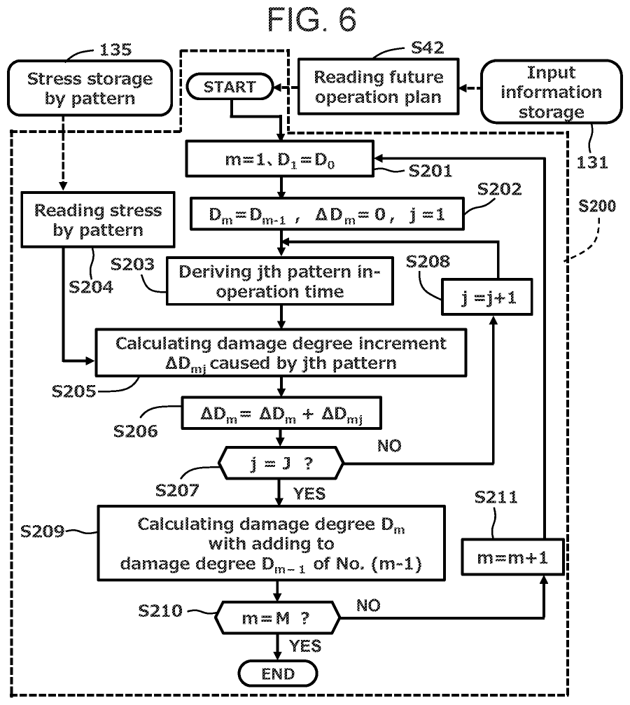

FIG. 6 is a flow chart illustrating a procedure of a future prediction calculation step (future prediction step) S200 performed by the future predictor 127 of the damage degree management system 100 according to the first embodiment. FIG. 6 illustrates details of the procedure of the future prediction step S200 continued from a future operation plan reading step S42 to be described later while citing FIG. 11. In the future prediction step S200, the crack propagation degree is calculated based on a stress history previously calculated for each pattern and housed in the stress storage by pattern 135. Based on the crack length as a result of integrating the calculated crack propagation degrees of each pattern, the crack length is converted into the crack depth, and then the damage degree D, namely, a ratio of the crack propagation degree to the critical crack depth dₜₕ for each year is calculated.

First, the future predictor 127 sets m to 1, and sets D₁ to D₀ (step S201). Here, m indicates a year such as a year 2045, for example. Further, D₀ is an initial value of the damage degree calculation in the initial year of the future calculation (for example, the year to which the present belongs, or the following year). For example, if m=1 indicates the year to which the present belongs, D₀ is a present damage degree, namely, a present value in the fixed cycle calculation. The value of D₀ is housed in the calculation result storage 134. Further, the calculation result storage 134 houses the latest damage degree calculated by the following steps.

Next, the future predictor 127 sets Dₘ to Dₘ₋₁, sets ΔDₘ to 0, and sets j to 1 (step S202). Specifically, the initial value of the crack length of the calculation target year is set to the crack length at the end of the previous year. Here, j (j=1 to J) is a number of future operation pattern on the input screen 142 in FIG. 4. The respective start up modes related to the “start up pattern” in the table C and the respective patterns related to the “operation pattern” in the table G are arranged in serial order and the total number thereof is set to J, and in the case of the input screen 142 illustrated in FIG. 4, for example, J is 6 (=3+3).

Next, the future predictor 127 derives the in-operation time of the j-th pattern (step S203). Concretely, the future predictor 127 multiplies the availability factor of the j-th pattern in the m-th year input from the user interface 140 and housed in the input information storage 131, by a total time of one year, to thereby calculate the in-operation time of the j-th pattern.

Next, the future predictor 127 reads, from the stress storage by pattern 135, the previously-calculated stress-by-pattern (S204). Next, the future predictor 127 calculates a contribution amount Δdj per one hour to the damage degree based on the stress of the j-th pattern, and then multiplies the contribution amount Δdj per one hour to the damage degree by the in-operation time of the j-th pattern, to thereby derive a damage degree increment ΔDₘⱼ due to the j-th pattern (step S205).

Next, the future predictor 127 sequentially adds the damage degree increment ΔDₘⱼ of the j-th pattern derived in step S205, to thereby calculate the damage degree increment ΔDₘ in the m-th year (step S206). Next, the future predictor 127 determines whether or not j has reached J (step S207), and when j has not reached J (NO in step S207), the future predictor 127 adds 1 to j (step S208), and repeats the processing from step S203 to step S207.

When the future predictor 127 determines that j has reached J (YES in step S207), it reads the damage degree Dₘ₋₁ in the (m−1)-th year housed in the calculation result storage 134, and adds the damage degree increment ΔDₘ in the m-th year calculated in step S206 to the damage degree Dₘ₋₁, to thereby calculate a new damage degree Dₘ in the m-th year (step S209). The calculation result storage 134 houses the new damage degree Dₘ (namely, the new ratio of the crack depth to the critical crack depth dₜₕ) as the damage degree Dₘ in the m-th year.

Next, the future predictor 127 determines whether or not m has reached M (step S210), and when m has not reached M (NO in step S210), the future predictor 127 adds 1 to m (step S211), and repeats the processing from step S202 to step S210. When m has reached M (YES in step S210), the future prediction step S200 is terminated.

### <Output Screen>

FIG. 7 illustrates an output screen 143 indicating one example of results of the fixed cycle calculation and the future prediction calculation regarding the high-pressure outer casing 11b as an example of the turbine casing 10b to be displayed on the user interface 140 in the damage degree management system 100 according to the first embodiment.

At an A portion on the top, a heading of “Remaining Life Prediction for High Temperature Steam Turbine Components” is displayed.

At a B portion below the heading, a name of a relevant plant is displayed.

At a C portion below the B portion, a name of a target component is displayed. At the C portion, names of target component are displayed by a pull-down display displayed by pressing a check portion on the right side, and a selected one is displayed. In the case of the output screen 143, the “high-pressure outer casing” (“HP Outer Casing”) is selected and displayed as the target component.

At a D portion below the heading of the C portion, the entire diagram of the high-pressure turbine 11 including the target component selected at the C portion is displayed. Further, a surrounding portion D1 indicates to which part in the entire diagram the selected target component corresponds.

At an E portion on the right side of the entire diagram of the D portion, a diagram of the selected target component is displayed. In the example of the output screen 143, a diagram of the high-pressure outer casing is displayed. Further, in the diagram of the target component at the E portion, an evaluation part is displayed by an outlined circle mark E1. On the output screen 143, a case where the number of evaluation part is one is exemplified, but a plurality of evaluation parts may also be displayed. In this case, the evaluation parts may be distinguished by changing types of lines, by different colors, or the like.

At a lower portion of the output screen 143, a graph K indicating the results of the fixed cycle calculation and the future prediction calculation is displayed. A horizontal axis of the graph indicates serial years, and a display position of the year is set to an intermediate time point of each of the serial years (June 30, for example). Further, a vertical axis of the graph indicates a “crack propagation depth to criteria [%]” (“Crack depth vs Criteria”), namely, a damage degree. Here, the “criteria” means the “critical crack depth dₜₕ”.

At a G portion above the graph K, options of “5 years”, “10 years”, “15 years”, and “20 years” are displayed. In the case of the output screen 143, “5 years” is selected, so that as the serial years on the horizontal axis of the graph K, past 5 years are displayed on the left side, and future 5 years are displayed on the right side of a solid line H1 that indicates the present and set at a center of the horizontal axis.

In the graph K, a broken line H2 indicating a threshold value for inspection is displayed, in the horizontal axis direction, at a time point of 10 years from the start of use of the relevant equipment, namely, the high-pressure outer casing. Further, in the vertical axis direction, a broken line H3 indicating a replacement threshold value is displayed.

A curve L1 in the graph K is a curve indicating the result of the fixed cycle calculation up to the present. Further, a curve L2 is a curve indicating the result of the future calculation. At an H portion at the upper right of the graph K, the evaluation part indicated by the curve is displayed. Note that the display of the curves L1 and L2 is set to employ a method of discrimination (based on the type of line, color, and the like) corresponding to the E1 portion indicating the inspection target displayed at the E portion.

As will be described later, the future prediction calculation processing of creating the future curve L2 is performed only when it is determined that the future operation plan has been input. An initial value of the damage degree at this time is a final value when it is determined that the future operation plan has been input. On the other hand, the fixed cycle calculation of the damage degree of creating the past curve L1 is performed for each damage degree calculation cycle (every hour, for example). Therefore, the past curve L1 changes hourly, for example, and a final value of the past curve L1, namely, an intersection point of the past curve L1 with the solid line H1 increases continuously. Accordingly, a deviation between the final value of the past curve L1, namely, the intersection point of the past curve L1 with the solid line H1, and a starting point of the future curve L2, namely, an intersection point of the future curve L2 with the solid line H1 increases hourly.

The graph K in FIG. 7 indicates a case of a time point where the final value of the past curve L1, namely, the intersection point of the past curve L1 with the solid line H1 and the starting point of the future curve L2, namely, the intersection point of the future curve L2 with the solid line H1 match, namely, a time point within one hour from when the future prediction calculation processing is performed and a result thereof is displayed as the future curve L2.

At the H portion at the upper right of the graph K, the evaluation part indicated by the curve is displayed. Note that the display of the curves L1 and L2 is set to employ a method of discrimination (based on the type of line, color, and the like) corresponding to the E1 portion indicating the inspection target displayed at the E portion.

At the upper right portion of the output screen 143, a table M as an alarm display indicating recommendation dates of inspection and replacement is displayed. Vertical rows in the table M indicate “Detail Inspection” and “Casing Replace”. Horizontal columns in the table indicate “Recommendation” and “Remaining Period”. In the table M, dates corresponding to the contents of the graph K and remaining periods based on the dates are displayed. Note that there is a case where the table M is displayed and there is a case where it is not displayed, depending on a determination result to be described later while citing FIG. 10 and FIG. 11.

Above the table M on the output screen 143, a pull-down selection field N having a selection display (“v” portion) is displayed. When the selection display is pressed, pull-down selection candidate screens such as the input screen 142 of the future operation plan and the input screen 141 of the excavation depth are displayed, and a screen to be transited can be selected.

Note that out of the items displayed on the output screen 143, the A portion, the B portion, the G portion, and the N portion are common to the respective output screens.

FIG. 8 illustrates an output screen 144 indicating one example of results of the fixed cycle calculation and the future prediction calculation regarding the intermediate-pressure turbine rotating part 12a as an example of the turbine rotor 10a to be displayed on the user interface 140 in the damage degree management system 100 according to the first embodiment. Hereinafter, only a part different from that of the output screen 143 of the high-pressure outer casing 11b will be explained.

In place of the C portion on the output screen 143, at a Ca portion on the output screen 144, “IP Rotor” selected from a pull-down display is displayed. Further, in accordance with this, at a Da portion, an entire diagram of the intermediate-pressure turbine 12 is displayed, and a target component is surrounded by D1a. Further, on the right side of the entire diagram Da, a diagram Ea of the target component is displayed. In the diagram Ea, evaluation parts Ea1 to Ea4 are displayed by outlined circle marks. The display uses mutually different types of lines for discrimination, but may also be distinguished by different colors or the like.

In the graph K, curves L11 to L14 indicating the fixed cycle calculation results and curves L21 to L24 indicating the future calculation results of the evaluation parts Ea1 to Ea4, respectively, are indicated. Further, at an Ha portion, names of evaluation parts corresponding to respective curves are displayed. Here, for the discrimination of the mutual evaluation parts, the same display is set to be used based on the types of lines or the colors, including the display in the diagram Ea of the target component.

In the turbine rotor 10a, different from the case of the turbine casing 10b, the threshold value is only the threshold value for inspection, so that a broken line H1 indicating a level of the threshold value for inspection is displayed in the vertical axis direction of the graph K. In correspondence to this, in a non-destructive inspection recommendation table Ma as an alarm display displayed at the upper right on the output screen 144, “Date” and “Remaining Period” of “Detail Inspection” are displayed. Note that there is a case where the non-destructive inspection recommendation table Ma is displayed and there is a case where it is not displayed, depending on the determination result to be described later while citing FIG. 10 and FIG. 11.

Next, each flow in a damage degree management method performed by the damage degree management system 100 according to the first embodiment will be explained.

### <Basic Environment Setting Processing>

FIG. 9 is a flow chart for explaining a basic environment setting step S10 in the damage degree management method performed by the damage degree management system 100 according to the first embodiment.

First, a program is written into the damage degree management system 100 (step S11). The written program is housed and stored in the program storage 133 of the damage degree management system 100. Here, when the program is written, data information such as material data such as mill sheet information, various parameters for calculation, and a set value, is written in an accompanied manner. The following steps presuppose a state in which the damage degree management system 100 is started up after installing the program therein.

Next, information of past periodic inspection is input or entered (step S12). The periodic inspection information is input via the information exchange terminal provided to the user interface 140. Note that an input function of the display screen of the user interface 140 may also be used.

Next, it is determined whether or not information of the turbine rotor 10a, the turbine casing 10b is recorded (step S13). When it is not determined that these records exist (NO in step S13), the present flow is terminated.

When it is determined that these records exist (YES in step S13), it is determined whether or not information of removing crack and flaw of the turbine casing 10b is recorded (step S14).

When it is not determined that there is the record of the removing crack and flaw of the turbine casing 10b (NO in step S14), registration of only the records related to the turbine rotor 10a and the turbine casing 10b is performed (step S16).

When it is determined that there is the record of the removing crack and flaw (excavation) of the turbine casing 10b (YES in step S14), a removing crack and flaw amount of the turbine casing 10b is first entered (step S15). The input of the removing crack and flaw amount is performed on the input screen of the removing crack and flaw amount of each part of the turbine casing 10b exemplified in FIG. 3. After that, the registration of the records related to the turbine rotor 10a and the turbine casing 10b is performed (step S16).

The above is the flow of the basic environment setting step S10.

### <Fixed Cycle Calculation Processing>

FIG. 10 is a flow chart for explaining a procedure of fixed cycle calculation processing in the damage degree management method performed by the damage degree management system 100 according to the first embodiment.

First, the progress controller 150 determines whether or not the power plant 1 is in operation (step S21). The determination uses the generator electric power, for example, out of the pieces of information stored in the measured information storage 132, and is performed based on determination whether or not the generator electric power is greater than a determination value (0.1 MW, for example) that takes a noise into consideration.

When it is not determined that the power plant 1 is in operation (NO in step S21), the flow is terminated without carrying out the fixed cycle calculation processing.

When it is determined that the power plant 1 is in operation (YES in step S21), the measured information acquiring part 110 acquires the measured information as operation data from the on-site control system 40 (step S22). Here, the measured information to be acquired is the steam conditions such as the main steam pressure, the main steam temperature, and the reheat steam temperature, the rotation number of the turbine rotor 10a, the condition values inside the turbine, and the condition values such as the temperature of the turbine casing 10b, as described above.

Next, the calculation of the damage degree in step S100 explained while citing FIG. 5, and so on are carried out. The generated calculation result is housed and stored in the calculation result storage 134.

The display information generator 128 generates display information based on the calculation result stored in the calculation result storage 134 and the information stored in the template storage 136 (step S23). Further, the display information generator 128 outputs the generated display information to the display information storage 137 and the user interface 140. The display information storage 137 stores the display information.

The user interface 140 displays the display information output from the display information generator 128 on the display part, as illustrated in FIG. 7 and FIG. 8 (step S24).

Here, the display information generator 128 outputs the display information based on the calculation result to the display information storage 137 and the user interface 140 for each damage degree calculation cycle (one hour, for example). Accordingly, the curve from the past to the present in the graph indicating the calculation result exemplified by the output screens 143 and 144 regarding the past damage degree displayed on the display part, is updated for each damage degree calculation cycle.

The processing from step S21 to step S24 described above is repeated for each damage degree calculation cycle, namely, every hour, for example. Accordingly, the curve of the fixed cycle calculation result displayed in the graph K exemplified by the output screen 143 in FIG. 7 and the output screen 144 in FIG. 8 is updated for each damage degree calculation cycle.

Next, the progress controller 150 performs determination regarding each of the turbine rotor 10a and the turbine casing 10b being management targets, based on the calculation result of the damage degree based on the calculation result in step S100. These determinations are also performed for each damage degree calculation cycle (one hour, for example).

First, the determination regarding the turbine rotor 10a performed by the progress controller 150 based on the damage degree based on the calculation result in step S100 will be explained.

The progress controller 150 determines whether or not the damage degree based on the calculation result in step S100 has reached a threshold value for inspection of the turbine rotor 10a (step S25).

When it is not determined that the damage degree has reached the threshold value for inspection of the turbine rotor 10a (NO in step S25), this determination is repeated for each damage degree calculation cycle.

When it is determined that the damage degree has reached the threshold value for inspection of the turbine rotor 10a (YES in step S25), the progress controller 150 outputs information regarding the date at which the damage degree has reached the threshold value for inspection (information related to the recommended inspection timing) to the calculation result storage 134. The calculation result storage 134 stores this information. The display information generator 128 generates display information based on the calculation result stored in the calculation result storage 134 and the information stored in the template storage 136 (step S26). Further, the display information generator 128 outputs the generated display information to the display information storage 137 and the user interface 140. The display information storage 137 stores the display information.

The user interface 140 displays a screen including the information related to the recommended inspection timing, based on the display information output from the display information generator 128 (step S27). Here, the information related to the recommended inspection timing on the screen corresponds to a part of “Detail Inspection” indicated in the table M in the case of the output screen 143 illustrated in FIG. 7 and the table Ma in the case of the output screen 144 illustrated in FIG. 8.

Next, the determination regarding the turbine casing 10b performed by the progress controller 150 based on the damage degree based on the calculation result in step S100 will be explained.

First, the progress controller 150 determines whether or not the damage degree has reached a threshold value for inspection of the turbine casing 10b (step S28). Here, the threshold value for inspection of the turbine casing 10b corresponds to a time point at which a predetermined period (10 years, for example) has elapsed from the start of use of the turbine casing 10b, and thus the threshold value for inspection is not the damage degree in the determination. Specifically, it is determined whether or not there exists an intersection point between the dotted line H2 indicating the threshold value for inspection and L1 indicating the damage degree displayed in the graph K in FIG. 7. This threshold value for inspection also functions as the future damage degree related information.

When it is not determined that the damage degree has reached the threshold value for inspection of the turbine casing 10b (NO in step S28), this determination is repeated for each damage degree calculation cycle.

When it is determined that the damage degree has reached the threshold value for inspection of the turbine casing 10b (YES in step S28), the progress controller 150 further determines whether or not the damage degree based on the calculation result in step S100 has reached a threshold value for threshold value for exchanging turbine casing 10b (step S29).

When it is not determined that the damage degree based on the calculation result in step S100 has reached the threshold value for threshold value for exchanging turbine casing 10b (NO in step S29), the display information generator 128 generates display information based on the information related to the recommended inspection timing housed in the input information storage 131 (step S30). Further, the display information generator 128 outputs the generated display information to the display information storage 137 and the user interface 140. The display information storage 137 stores the display information. The user interface 140 displays a screen including the information related to the recommended inspection timing as an alarm display, based on the display information output from the display information generator 128 (step S31). Here, the information related to the recommended inspection timing on the screen corresponds to a part of “Detail Inspection” indicated in the table M on the output screen 143, and the broken line H2 indicating the recommended inspection timing in the graph K illustrated in FIG. 7.

When it is determined that the damage degree based on the calculation result in step S100 has reached the threshold value for threshold value for exchanging turbine casing 10b (YES in step S29), the progress controller 150 outputs information regarding the date at which the damage degree has reached the replacement threshold value (information related to the replacement recommendation date) to the calculation result storage 134. The calculation result storage 134 stores this information. The display information generator 128 generates display information based on the calculation result stored in the calculation result storage 134 and the information stored in the template storage 136 (step S32).

Further, the display information generator 128 outputs the generated display information to the display information storage 137 and the user interface 140. The display information storage 137 stores the display information. The user interface 140 displays a screen including the information related to the replacement recommendation date, based on the display information output from the display information generator 128 (step S33). Here, the information related to the replacement recommendation date on the screen corresponds to a part of “Casing Replace” indicated in the table M in the case of the output screen 143 illustrated in FIG. 7.

The above is the flow of the fixed cycle calculation processing. Next, a flow of the future prediction calculation processing will be explained.

### <Future Prediction Calculation Processing>

FIG. 11 is a flow chart for explaining a procedure of future prediction calculation processing in the damage degree management method performed by the damage degree management system 100 according to the first embodiment.

Here, on the date of the introduction of the damage degree management system 100, the future operation plan illustrated in FIG. 4 is initially set. After the introduction, a user inputs the future operation plan in a unit of one year, in the table C and the table G on the input screen 142 illustrated in FIG. 4 of the user interface 140.

For example, by pressing the selection button of the pull-down selection field N in the screen examples such as the output screen 143 illustrated in FIG. 7 and the output screen 144 illustrated in FIG. 8, selection screen items including the input screen 142 of the future operation plan are displayed in a pull-down display. When the input screen 142 is selected at the pull-down selection field N, a screen of the display part of the user interface 140 is switched to the input screen 142 of the future operation plan illustrated in FIG. 4. At this time, the display information generator 128 inputs information related to the selection of the input screen 142 from the user interface 140, and outputs display information for displaying the input screen 142 to the user interface 140.

The user inputs the future operation plan, and then presses the “Save” display on the input screen 142 in FIG. 4. The user interface 140 receives the input from the “Save” display, and outputs information related to the future operation plan to the input information storage 131. The input information storage 131 stores the information related to the future operation plan.

Upon receiving information from the user interface 140 in accordance with the pressing of the “Save” display, the progress controller 150 determines that the future operation plan has been input.

Under the background as described above, in the procedure of the future prediction calculation processing illustrated in FIG. 11, the progress controller 150 first determines whether or not the future operation plan has been input (step S41).

When, in the determination in step S41, it is determined that the future operation plan has not been input (NO in step S41), the progress controller 150 repeats the determination in step S41.

When, in the determination in step S41, it is determined that the future operation plan has been input (YES in step S41), the future predictor 127 reads the program for executing the future prediction calculation from the program storage 133, and the future operation plan stored in the input information storage 131 (step S42).

Next, the future predictor 127 calculates a future crack propagation degree, a future crack length, a future crack depth, and a future damage degree (the future damage degree and so on) by the calculation method explained while referring to FIG. 6, and outputs a calculation result to the calculation result storage 134 (step S200). The calculation result storage 134 stores the calculation result.

The display information generator 128 generates display information based on the calculation result stored in the calculation result storage 134 and the information stored in the template storage 136 (step S43). Further, the display information generator 128 outputs the generated display information to the display information storage 137 and the user interface 140. The display information storage 137 stores the display information.

The user interface 140 displays the display information output from the display information generator 128 on the display part as illustrated in the examples of FIG. 7 and FIG. 8 (step S44).

Here, the display information generator 128 executes the calculation processing of the future damage degree and so on in step S200 every time it is determined that the future operation plan has been input in step S41 (YES in step S41), and outputs the display information based on the calculation result to the display information storage 137 and the user interface 140. Accordingly, the graph K (FIG. 7 and FIG. 8) indicating the calculation result regarding the future damage degree displayed on the display part, is updated every time the calculation processing of the future damage degree and so on in step S200 is executed. In other words, the graph K indicating the calculation result regarding the future damage degree is updated every time the information in accordance with the pressing of “Save” at the K portion on the input screen 142 of the future operation plan is received.

The processing from step S41 to step S44 described above is repeated every time it is determined that the future operation plan has been input. Accordingly, the curves indicating the calculation results regarding the future damage degrees displayed in the graph K exemplified by the output screen 143 in FIG. 7 and the output screen 144 in FIG. 8, are updated each time.

Next, the progress controller 150 performs determination regarding each of the turbine rotor 10a and the turbine casing 10b based on the damage degree based on the calculation result in step S200. These determinations are also performed every time the future operation plan is input.

First, the turbine rotor 10a will be explained.

The progress controller 150 determines whether or not the damage degree based on the calculation result in step S200 has reached a threshold value for inspection of the turbine rotor 10a (step S45).

When it is not determined that the damage degree has reached the threshold value for inspection of the turbine rotor 10a (NO in step S45), the display information generator 128 generates display information based on the calculation result stored in the calculation result storage 134 and the information stored in the template storage 136 (step S46). Details are as follows.

First, at the stage of delivery of the damage degree management system 100 from its manufacturer to a customer of the power plant 1, there is a case where an initial environmental setting is performed in the manufacturer, and the table Ma as the alarm display is displayed on the output screen 144 of the damage degree management system 100 exemplified in FIG. 8. Alternatively, the table Ma as the alarm display is already displayed in some cases before the determination this time in step S45.

Therefore, when, in the determination this time in step S45, it is not determined that the damage degree has reached the threshold value for inspection of the turbine rotor 10a (NO in step S45), the display information generator 128 generates display information including no display of the table Ma as the alarm display (step S46). Similar display information is output also when the display with no alarm display is already performed, and in this case, it is possible to employ a method in which the same display information is not output again.

Further, the display information generator 128 outputs the generated display information to the display information storage 137 and the user interface 140. The display information storage 137 houses and stores the display information. The user interface 140 displays a screen based on the generated information (step S47). After that, the processing of step S45 and thereafter is repeated.

When it is determined that the damage degree has reached the threshold value for inspection of the turbine rotor 10a (YES in step S45), the progress controller 150 outputs information regarding the date at which the damage degree has reached the threshold value for inspection (information related to the recommended inspection timing) to the calculation result storage 134. Here, in the case of the graph K on the output screen 144 exemplified in FIG. 8, the curve L24 and so on indicating the future damage degrees change linearly in each year. Specifically, the curve L24 and so on have a zigzag shape. The information regarding the date can be obtained by calculating a value on the horizontal axis of a point at which the straight line H1 indicating the threshold value for inspection and the curve L24 intersect.

The calculation result storage 134 stores this information. The display information generator 128 generates display information based on the calculation result stored in the calculation result storage 134 and the information stored in the template storage 136 (step S48). Further, the display information generator 128 outputs the generated display information to the display information storage 137 and the user interface 140. The display information storage 137 stores the display information.

The user interface 140 displays a screen including information related to the recommended inspection timing, based on the display information output from the display information generator 128 (step S49). Here, the information related to the recommended inspection timing on the screen corresponds to the table Ma, and the dotted line H1 indicating the threshold value for inspection in the graph K on the output screen 144 in FIG. 8 illustrated as an example.

Next, a flow of determination regarding the turbine casing 10b performed by the progress controller 150 based on the damage degree based on the calculation result in step S200 will be explained.

First, the progress controller 150 determines whether or not the damage degree has reached a threshold value for inspection of the turbine casing 10b (step S51). Here, the threshold value for inspection of the turbine casing 10b corresponds to a time point at which a predetermined period (10 years, for example) has elapsed from the start of use of the turbine casing 10b, and thus the threshold value for inspection is not the damage degree in the determination. Specifically, it is determined whether or not there exists an intersection point between the dotted line H2 indicating the threshold value for inspection and L1 indicating the damage degree displayed in the graph K in FIG. 7, similarly to step S28. This threshold value for inspection also functions as the future damage degree related information.

Specifically, when it is not determined that the damage degree has reached the threshold value for inspection of the turbine casing 10b (NO in step S51), the display information generator 128 generates display information based on the calculation result stored in the calculation result storage 134 and the information stored in the template storage 136 (step S52). Further, the display information generator 128 outputs the generated display information to the display information storage 137 and the user interface 140. The display information storage 137 stores the display information. The user interface 140 displays a screen including the information related to the recommended inspection timing, based on the display information output from the display information generator 128 (step S53).

Therefore, when, in the determination this time in step S51, it is not determined that the damage degree has reached the threshold value for inspection of the turbine casing 10b (NO in step S51), the display information generator 128 generates display information including no display of the table M as the alarm display (step S52). Similar display information is output also when the display with no alarm display is already performed, and in this case, it is possible to employ a method in which the same display information is not output again.

When it is determined that the damage degree has reached the threshold value for inspection of the turbine casing 10b (YES in step S51), the progress controller 150 further determines whether or not the damage degree based on the calculation result in step S200 has reached a threshold value for threshold value for exchanging turbine casing 10b (step S54).

When it is not determined that the damage degree based on the calculation result in step S200 has reached the threshold value for threshold value for exchanging turbine casing 10b (NO in step S54), the display information generator 128 generates display information based on the information related to the recommended inspection timing housed in the input information storage 131 (step S55). Further, the display information generator 128 outputs the generated display information to the display information storage 137 and the user interface 140. The display information storage 137 stores the display information. The user interface 140 displays a screen including the information related to the recommended inspection timing, based on the display information output from the display information generator 128 (step S56).

Here, the information related to the recommended inspection timing on the screen corresponds to a part of “Detail Inspection” indicated in the table M, and the broken line H2 indicating the recommended inspection timing in the graph K on the output screen 143 illustrated in FIG. 7.

When it is determined that the damage degree based on the calculation result in step S200 has reached the threshold value for threshold value for exchanging turbine casing 10b (YES in step S54), the progress controller 150 outputs information regarding the date at which the damage degree has reached the replacement threshold value (information related to the replacement recommendation date) to the calculation result storage 134. The calculation result storage 134 stores this information. The display information generator 128 generates display information based on the calculation result stored in the calculation result storage 134 and the information stored in the template storage 136 (step S57).

Here, in the case of the graph K on the output screen 143 exemplified in FIG. 7, the curve L2 indicating the future damage degree changes linearly in each year. Specifically, the curve L2 has a zigzag shape. The information regarding the date can be obtained by calculating a value on the horizontal axis of a point at which the straight line H1 indicating the threshold value for inspection and the curve L2 intersect.

Further, the display information generator 128 outputs the generated display information to the display information storage 137 and the user interface 140. The display information storage 137 stores the display information. The user interface 140 displays a screen including the information related to the replacement recommendation date, based on the display information output from the display information generator 128 (step S58). Here, the information related to the replacement recommendation date on the screen corresponds to a part of “Casing Replace” indicated in the table M, and the dotted line H3 indicating the replacement threshold value in the graph K in the case of the output screen 143 illustrated in FIG. 7.

As described above, based on the procedure of the future prediction calculation processing, the information regarding the future damage degree on the output screens 143 and 144 exemplified in FIG. 7 and FIG. 8 is updated. According to the future operation plan, the information regarding the future damage degree on the output screens 143 and 144 changes. Further, according to the future operation plan, the recommended inspection timing and the replacement recommendation date also change.

With the use of the damage degree management system 100 of the present embodiment described above, it is possible to display the damage degree from the past to the present predicted based on the operation data of the actual machine, and the future damage degree predicted based on the operation condition assumed in the future, in chronological order, in the graph K on the output screens 143 and 144 of the display part of the user interface 140. Accordingly, the user can visually confirm the change with time of the damage degree.

Further, in the damage degree management system 100, it is possible to display the lines of the threshold value for inspection and the replacement threshold value in the graph K on the output screen 143 exemplified regarding the turbine casing 10b, and the line of the threshold value for inspection in the graph K on the output screen 144 exemplified regarding the turbine rotor 10a, respectively. Accordingly, the user can visually confirm the recommended inspection timing and the replacement recommendation date regarding the turbine casing 10b, and can visually confirm the recommended inspection timing regarding the turbine rotor 10a.

Further, in the damage degree management system 100, it is possible to display the recommended inspection timing and the replacement recommendation date in the table M on the output screen 143 exemplified regarding the turbine casing 10b, and display the recommended inspection timing in the table Ma on the output screen 144 exemplified regarding the turbine rotor 10a, respectively, as the alarm display. Accordingly, the user can concretely recognize the recommended inspection timing and the replacement recommendation date. Further, by concretely recognizing the recommended inspection timing, the user can properly perform preparations for an adjustment of a process and a workplace, securement of budget, and so on in the corresponding periodic inspection. Further, regarding the turbine casing 10b, it is possible to properly perform production preparation for replacement, and preparations for an adjustment of a process and a workplace, securement of budget, and so on in the periodic inspection in which the replacement is to be performed.

In the damage degree management system 100, it is possible to display the calculation result of the future damage degree based on the operation condition input on the input screen 142 of the future operation plan illustrated in FIG. 4. Accordingly, by changing the operation condition on the input screen 142 of the future operation plan, the user can visually confirm a difference in the future damage degree based on the operation condition, in the graph K on the output screens 143 and 144. Further, the user can visually confirm a difference in the recommended inspection timing and the replacement recommendation date based on the future operation plan, in the alarm display such as the table M on the output screen 143 and the table Ma on the output screen 144.

### Second Embodiment

In the second embodiment, another example of information regarding a future damage degree displayed on the display part of the user interface 140 will be explained.

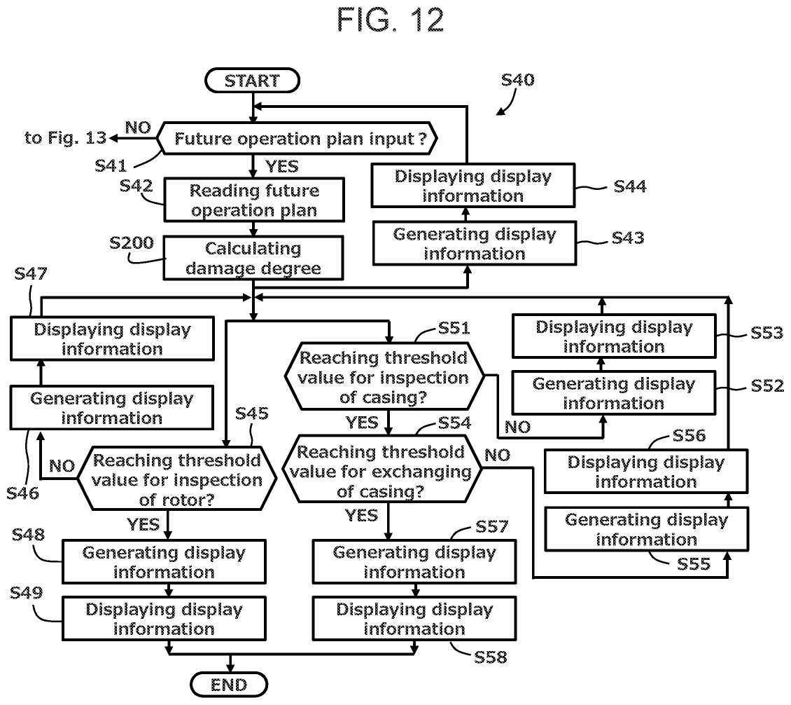

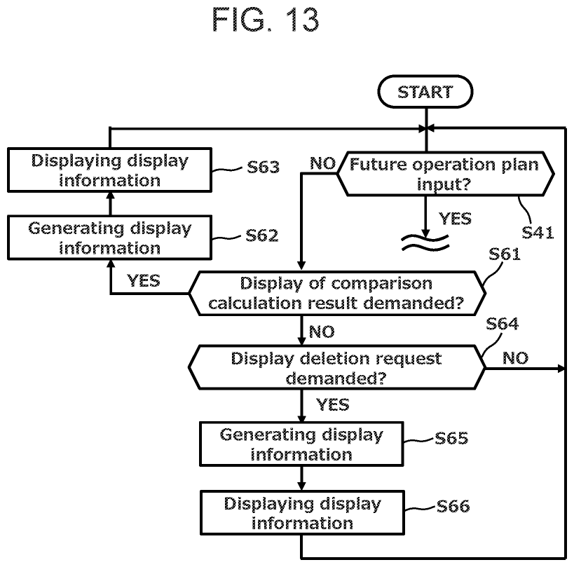

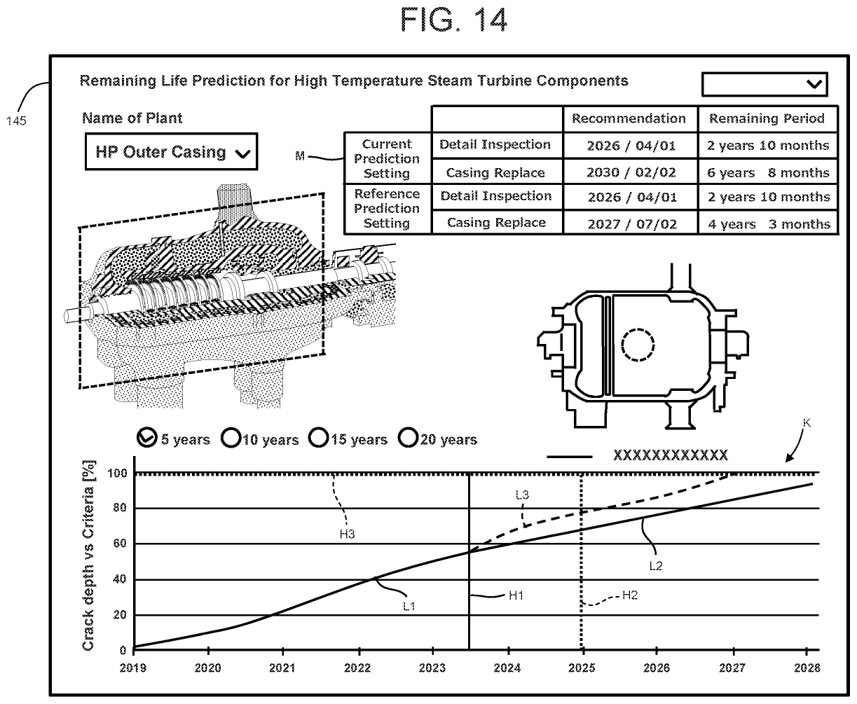

FIG. 12 and FIG. 13 are first and second flow charts for explaining future prediction calculation processing in the damage degree management system 100 according to the second embodiment. Note that due to the constitutional reason of the drawing, the flow chart cannot be illustrated by one chart, so that a flow chart continued from NO in step S41 in FIG. 12 will be illustrated in FIG. 13. FIG. 14 is a diagram illustrating one example of an output screen in the damage degree management system 100 according to the second embodiment. Note that in the second embodiment, parts having configurations same as those of the damage degree management system 100 of the first embodiment will be denoted by the same reference signs, and an overlapped explanation thereof will be omitted or simplified.

The damage degree management system 100 in the second embodiment is different from that in the first embodiment in that it is possible to simultaneously display a calculation result based on another future operation plan, on output screens 143 and 144 indicating the calculation results of the damage degree. Here, this different configuration will be mainly explained. Note that fixed cycle calculation processing of the crack propagation in the second embodiment is similar to the fixed cycle calculation processing in the first embodiment.

The future prediction calculation processing in the second embodiment illustrated in FIG. 12 and FIG. 13 corresponds to the future prediction calculation processing in the first embodiment to which processing from step S61 to step S66 is added.

Here, the user inputs the future operation plan, and then presses the selection display K of “Save” in FIG. 4. In the future prediction calculation processing in the second embodiment, the user interface 140 receives the input from the selection display K of “Save”, and outputs the information related to the future operation plan to the input information storage 131, similarly to the future prediction calculation processing in the first embodiment. The input information storage 131 stores the information related to the future operation plan.

Further, upon receiving the information from the user interface 140 in accordance with the pressing of the selection display K of “Save”, the progress controller 150 determines that the future operation plan has been input.

As illustrated in FIG. 12, the progress controller 150 determines whether or not the future operation plan has been input (step S41).

When, in the determination in step S41, it is determined that the future operation plan has been input (YES in step S41), the processing from step S42 to step S44 via step S200 is executed in a manner as described above. Further, after the processing of step S44, the processing of step S41 is executed again, in a manner as described above.

On the other hand, when, in the determination in step S41, it is determined that the future operation plan has not been input (NO in step S41), the display information generator 128 determines whether or not there is a display request of a result calculated based on another future operation plan (reference calculation result), as illustrated in FIG. 13 (step S61). The reference calculation result is a calculation result that is already predicted based on another future operation plan, and is stored in the calculation result storage 134. Note that the other future operation plan functions as a second future operation plan, and the reference calculation result functions as second future damage degree related information.

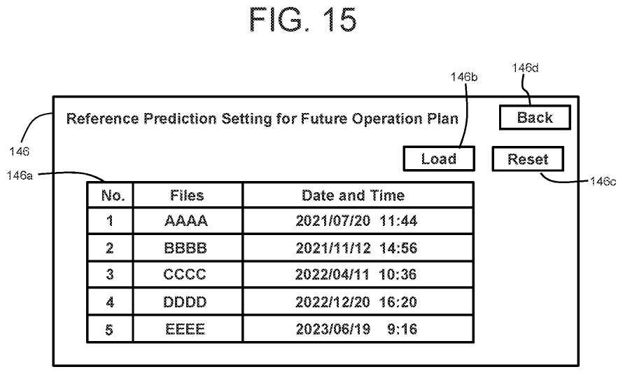

Here, FIG. 15 is a diagram illustrating one example of a selection screen 146 for selecting the reference calculation result to be displayed on the user interface 140 in the damage degree management system according to the second embodiment.

For example, by pressing the pull-down selection field N on the output screen 143 illustrated in FIG. 7, selection items such as the selection screen 146 are displayed in the pull-down selection field N, which is not illustrated though. Further, when the selection screen 146 in the selection items of the pull-down selection field N is selected, the screen of the display part of the user interface 140 is switched to the selection screen 146 illustrated in FIG. 15. At this time, the display information generator 128 inputs information related to the selection of the selection screen 146 from the user interface 140, and outputs display information for displaying the selection screen 146 to the user interface 140.

A list of calculation results that are already calculated and stored in the calculation result storage 134, is displayed at a list display part 146a on the selection screen 146 in FIG. 15. Further, here, an example of the list display part 146a that also displays date and time of storing the calculation result in the calculation result storage 134, is indicated. On the list display part 146a, for example, file names of five calculation results are displayed in chronological order of storing the calculation results in the calculation result storage 134. Note that the configuration displayed on the list display part 146a is not limited to this. The list display part 146a is only required to display a list of already-calculated calculation results.

The user selects, from the list displayed at the list display part 146a, the file name of the calculation result to be displayed in the graph K on the output screen 143 in FIG. 7, for example, as the reference calculation result. Subsequently, the user presses a Load button 146b on the selection screen 146. When the user presses the Load button 146b, the screen is switched to the output screen 143 indicating the calculation result.

Note that a BACK button 146d is a button that is pressed when returning to the output screen 143, for example, without pressing the Load button 146b or a Reset button 146c.

Upon receiving a signal based on the pressing of the Load button 146b from the user interface 140, the display information generator 128 determines that there is a display request of the reference calculation result in step S61.

When, in the determination in step S61, it is determined that there is the display request of the reference calculation result (YES in step S61), the display information generator 128 generates display information based on the calculation result stored in the calculation result storage 134 and the information stored in the template storage 136 (step S62). Here, the display information generator 128 reads both the calculation result based on the future operation plan and the selected reference calculation result stored in the calculation result storage 134. Further, the display information generator 128 outputs the generated display information to the display information storage 137 and the user interface 140. The display information storage 137 stores the display information.

The user interface 140 displays the display information output from the display information generator 128 on the display part, as illustrated in FIG. 14 (step S63). As illustrated in FIG. 14, on an output screen 145, both the calculation result based on the future operation plan and the reference calculation result are displayed as the future damage degrees.

Concretely, as the future damage degree, a damage degree in each calculation result is indicated in chronological order. Note that the damage degree in the reference calculation result is indicated by a broken line L3. Further, in a table M as an alarm display, a recommended inspection timing and a replacement recommendation date in each calculation result are displayed. Note that as illustrated in FIG. 14, the damage degree in the past crack propagation degree is also indicated in chronological order.

Note that the recommended inspection timing in the reference calculation result functions as a second recommended inspection timing, and the replacement recommendation date in the reference calculation result functions as a second replacement recommendation date.

When, in the determination in step S61, it is determined that there is no display request of the reference calculation result (NO in step S61), the display information generator 128 determines whether or not there is a display deletion request of the reference calculation result (step S64).

Here, the user can delete the reference calculation result indicated on the output screen 145 in FIG. 14, by pressing the Reset button 146c on the selection screen 146 in FIG. 15. Upon receiving a signal based on the pressing of the Reset button 146c from the user interface 140, the display information generator 128 determines that there is the display deletion request of the reference calculation result in step S64. Note that when the user presses the Reset button 146c, the screen is switched to the display screen indicating the calculation result.

When, in the determination in step S64, it is determined that there is the display deletion request of the reference calculation result (YES in step S64), the display information generator 128 generates display information based on the calculation result stored in the calculation result storage 134 and the information stored in the template storage 136 (step S65). Here, the display information generator 128 reads the calculation result based on the future operation plan stored in the calculation result storage 134. Subsequently, the display information generator 128 outputs the generated display information to the display information storage 137 and the user interface 140. The display information storage 137 stores the display information.

The user interface 140 displays the display information output from the display information generator 128 on the display part, as illustrated in FIG. 7 (step S66). Specifically, the reference calculation result is deleted and only the calculation result based on the future operation plan is displayed on the output screen 143, as illustrated in FIG. 7.

When, in the determination in step S64, it is determined that there is no display deletion request of the reference calculation result (NO in step S64), the processing returns to step S41.

Further, the progress controller 150 performs the processing in step S200, and then determines whether or not the damage degree has reached a replacement threshold value based on the calculation result in step S200, in a manner as described above (steps S45 and S51). Further, the processing from step S46 to step S58 is executed in a manner as described above.

The information regarding the future damage degree on the output screen 145 is updated every time the information in accordance with the pressing of the selection display K of “Save” on the input screen 142 of the future operation plan, and the Load button 146b or the Reset button 146c on the selection screen 146 of the reference calculation result is received.

Note that here, one example of selecting one calculation result as the reference calculation result is described, but it is also possible to set that a plurality of reference calculation results can be selected.

With the use of the damage degree management system 100 of the second embodiment described above, it is possible to obtain operations and effects similar to those of the damage degree management system 100 of the first embodiment.

Further, with the use of the damage degree management system 100 of the second embodiment, it is possible to display, on the output screen 145, both the calculation result predicted based on the future operation plan and the reference calculation result, as the future damage degree.

Accordingly, the user can visually confirm, in the graph K on the output screen 145, the difference between the damage degree in the calculation result based on the future operation plan and the damage degree in the reference calculation result. Further, the user can visually confirm, in the table M as the alarm display on the output screen 145, the difference between the recommended inspection timing and the replacement recommendation date in the calculation result based on the future operation plan and the recommended inspection timing and the replacement recommendation date in the reference calculation result.

As described above, according to the explained first embodiment, it becomes possible to provide the damage degree management system for the steam turbine with which it is possible to recognize, in chronological order, the damage degree from the past to the present predicted based on the measured information and the future damage degree predicted based on the future operation plan.

### Other Embodiments

Although the embodiments of the present invention have been described above, the embodiments have been presented by way of example only, and are not intended to limit the scope of the inventions. Further, the characteristics of the respective embodiments may also be combined. Furthermore, the embodiments may be embodied in a variety of other forms, and various omissions, substitutions, and changes in the form of the embodiments described herein may be made without departing from the spirit of the inventions. The accompanying claims and their equivalents are intended to cover such forms or modifications as would fall within the scope and spirit of the invention.

What is claimed is:

1. A damage degree management system for a steam turbine high temperature component, the system comprising
a display information generator configured to generate display information for displaying:
past damage degree related information indicating information regarding a damage degree of the steam turbine high temperature component from the past to the present calculated based on measured information; and
future damage degree related information indicating information regarding a future damage degree of the steam turbine high temperature component in the future calculated based on a future operation plan input through an input screen of a user interface and the past damage degree related information.

2. The damage degree management system for the steam turbine high temperature components according to claim 1, wherein
the display information generator generates the display information for making both the past damage degree related information and the future damage degree related information to be displayed in chronological order.

3. The damage degree management system for the steam turbine high temperature components according to claim 1, wherein
the display information generator generates the display information for making the past damage degree related information to be displayed, at a predetermined time interval.

4. The damage degree management system for the steam turbine high temperature components according to claim 1, wherein
the display information generator generates the display information for making the future damage degree related information to be displayed, every time the future operation plan is input.

5. The damage degree management system for the steam turbine high temperature components according to claim 1, wherein:
the high temperature parts include a turbine casing; and
the display information generator generates the display information for making information related to a predetermined threshold value for inspection at which an inspection of the turbine casing is recommended, to be displayed.

6. The damage degree management system for the steam turbine high temperature components according to claim 1, wherein:
the high temperature parts include a turbine casing; and
the display information generator generates the display information for making information regarding a recommended inspection timing at which an inspection of the turbine casing is recommended and information related to a replacement recommendation date at which replacement of the turbine casing is recommended, calculated based on the future damage degree, to be displayed.

7. The damage degree management system for the steam turbine high temperature components according to claim 1, wherein:
the high temperature parts include a turbine rotating part; and
the display information generator generates the display information for making information related to a recommended inspection timing calculated based on the future damage degree and at which an inspection of the turbine rotating part is recommended, to be displayed.

8. The damage degree management system for the steam turbine high temperature components according to claim 1, wherein
the high temperature parts include a high-pressure turbine rotating part, an intermediate-pressure turbine rotating part, a high-pressure outer casing, a high-pressure inner casing, an intermediate-pressure outer casing, and an intermediate-pressure inner casing, as high temperature parts.

9. The damage degree management system for the steam turbine high temperature components according to claim 1, wherein
the display information generator generates the display information for making second damage degree related information indicating information regarding a second future damage degree of the high temperature parts in the future calculated based on a second future operation plan input through an operation using a user interface screen and the past damage degree related information, to be further displayed.

10. The damage degree management system for the steam turbine high temperature components according to claim 9, wherein:
the high temperature parts include a turbine casing; and
the display information generator generates the display information for making information related to a recommended inspection timing at which an inspection of the turbine casing is recommended and a replacement recommendation date at which replacement of the turbine casing is recommended, calculated based on a second damage degree, to be displayed.

11. The damage degree management system for the steam turbine high temperature components according to claim 9, wherein:
the high temperature parts include a turbine rotating part; and
the display information generator generates the display information for making a recommended inspection timing calculated based on a second damage degree and at which an inspection of the turbine rotating part is recommended, to be displayed.
